(19) United States
(12) Patent Application Publication
(10) Pub. No.: US 2006/0244367 A1
(43) Pub. Date: Nov. 2, 2006

(54) Photoluminescent liquid crystal display

(76) Inventors: Seoung-jae Im, Seoul (KR); Byung-ki Kim, Gunpo-si (KR); Jae-young Choi, Suwon-si (KR); In-sun Hwang, Suwon-si (KR); Hae-il Park, Seoul (KR)

Correspondence Address: CANTOR COLBURN, LLP, 55 GRIFFIN ROAD SOUTH, BLOOMFIELD, CT, 06002, US

(21) Appl. No.: 11/412,753

(22) Filed: Apr. 27, 2006

(30) Foreign Application Priority Data
Apr. 27, 2005 (KR) 10-2005-0034918
May 3, 2005 (KR) 10-2005-0037049

(51) Int. Cl. H01J 1/62

(52) U.S. Cl. 313/503

(57) ABSTRACT

A photoluminescent liquid crystal display (PL-LCD) includes: a front plate and a rear plate; liquid crystals disposed between the front and rear plates; an electrode that is disposed on an inner surface of each of the front and rear plates and forms an electric field in the liquid crystals; an emitting layer that is formed on the front plate and emits visible light by being excited by light having a wavelength of about 390 nm to about 410 nm; a light source unit that is formed on a rear side of the rear plate and includes a lamp emitting near blue-UV light having a wavelength of about 390 nm to about 410 nm toward the emitting layer; and a UV filter blocking UV rays in ambient light from entering a front side of the front plate.

This application claims priority to Korean Patent Application Nos. 10-2005-0034918, filed on Apr. 27, 2005, and 10-2005-0037069, filed on May 3, 2005, and all the benefits accruing therefrom under 35 U.S.C. §119, and the contents of which in their entirety are herein incorporated by reference.

### BACKGROUND OF THE INVENTION

1. Field of the Invention

The present invention relates to a liquid crystal display, and more particularly, to a photoluminescent liquid crystal display (“PL-LCD”) with high luminous efficiency.

2. Description of the Related Art

A liquid crystal display (“LCD”) is a non-active emissive display that requires an additional backlight device to display an image, and red (R), green (G) and blue (B) color filters for each pixel of the LCD to display a colored image.

The R, G and B color filters respectively emit R, G and B light in white light incident from the backlight device. These color filters transmit only light of certain wavelengths, thereby causing great light loss. Therefore, a backlight device with a higher luminance is needed to provide a sufficiently bright image.

U.S. Pat. Nos. 4,822,144 and 4,830,469 disclose PL-LCDs having a structure that excites phosphor using UV light and using a color filter to provide the LCD with a high luminous efficiency. The UV light used in the PL-LCDs is near visible UV light. Therefore, in the PL-LCDs, a UV-excitable phosphor, which differs from an electron beam-excitable phosphor used in conventional CRTs, is used.

The UV-excitable phosphor can be excited by ambient light due to UV rays in the ambient light. Therefore, the UV rays in the ambient light can excite phosphor regardless of whether the excitation of the phosphor is required to display an image on the LCD, thus lowering contrast ratio.

In addition, the PL-LCD disclosed in U.S. Pat. No. 4,830,469 has a structure in which a mercury lamp, which is a UV lamp emitting light having a wavelength of about 360 nm to about 370 nm, is used as a light source, and phosphor is formed on an inner surface of a front substrate. However, the UV light having a wavelength of about 360 nm to about 370 nm is partially absorbed by liquid crystals, and thus the amount of UV light contributing to the excitation of phosphor is reduced. In addition, the liquid crystals that have absorbed UV light deteriorate and have a reduced lifetime. Furthermore, since the PL-LCD is not a color-filter-free structure, light loss caused by the color filters still occurs.

### BRIEF SUMMARY OF THE INVENTION

The present invention provides a photoluminescent liquid crystal display (PL-LCD) that has improved luminous efficiency and extended lifetime by preventing the deterioration of liquid crystals caused by UV light exciting phosphors.

The present invention provides a PL-LCD that can display a quality image by preventing, for example, a decrease in contrast due to ambient light.

According to an exemplary embodiment of the present invention, a photoluminescent liquid crystal display includes: a front plate and a rear plate; liquid crystals disposed between the front and rear plates; an electrode that is disposed on an inner surface of each of the front and rear plates and forms an electric field in the liquid crystals; an emitting layer that is formed on the front plate and emits visible light by being excited by light having a wavelength of about 390 nm to about 410 nm; a light source unit that is formed on a rear side of the rear plate and includes a lamp emitting near blue-UV light having a wavelength of about 390 nm to about 410 nm toward the emitting layer; and a UV filter blocking UV rays in ambient light entering from a front side of the front plate.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic cross-sectional view of an exemplary embodiment of an LCD according to the present invention;

FIG. 2 is a diagram for explaining an example of a backlight unit of the LCD shown in FIG. 1;

FIG. 3 is a diagram for explaining another example of a backlight unit of the LCD shown in FIG. 1;

FIG. 4 is a schematic cross-sectional view of another exemplary embodiment of an LCD according to the present invention;

FIG. 5 is an enlarged cross-sectional view of a switching device and a pixel electrode of the LCD shown in FIGS. 1 and 4;

FIG. 6 is a graph of UV transmittance (or absorbance) of samples with respect to a wavelength of light;

FIGS. 7, 8 and 9 are graphs of photoluminescence of CdSe, CdS and CdSeS with respect to a wavelength of light; and

FIG. 10 is a graph of luminous intensity of conventional phosphors when excited by UV of a wavelength of 392 nm.

### DETAILED DESCRIPTION OF THE INVENTION

Hereinafter, the present invention will be described more fully with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, lengths and sizes of layers and regions may be exaggerated for clarity.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “below” or “lower” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

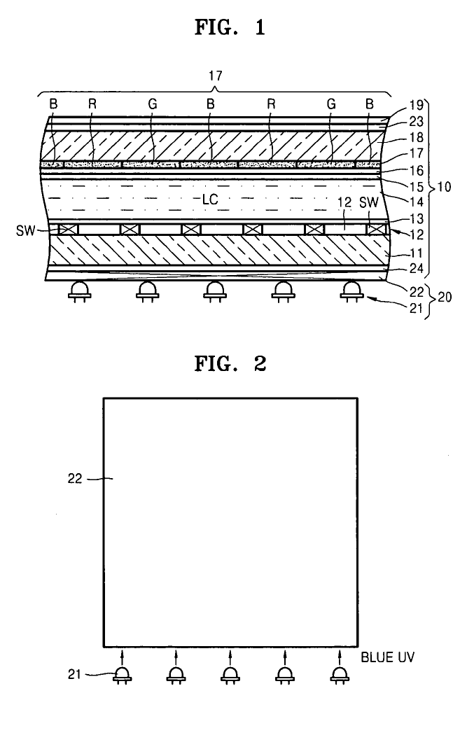

Referring to FIG. 1, an exemplary embodiment of an LCD according to the present invention includes a display panel 10 and a near blue-UV light source unit 20.

The display panel 10 includes a front plate 18 and a rear plate 11, which are separated a predetermined distance from one another, and a liquid crystal (“LC”) layer 14 is disposed in a space between the front and rear plates 18 and 11.

An emitting layer 17, which includes R, G and B layers, is disposed on an inner surface of the front plate 18, and a common electrode 16 and an upper orientation layer 15 are sequentially disposed on the emitting layer 17. Alternatively, the emitting layer 17 may be formed on an outer surface of the front plate 18. In this case, the emitting layer 17 needs to be protected by an additional protective substrate (not shown) or a protective film (not shown). Also, switching devices SW, such as thin film transistors (“TFT”), and a pixel electrode 12 are disposed on an inner surface of the rear plate 11, and a lower orientation layer 13 is disposed thereon. The emitting layer 17 emits colored light by absorbing near blue-UV light. The emitting layer 17 may be composed of a common phosphor or photoluminescent material in nanodot (“ND”) form, which will be described later.

A polarizing layer 23 and a UV filter 19, which is a feature of the present invention, are formed on the outer surface of the front plate 18.

The UV filter 19 can be a chemical blocking member absorbing UV light or a physical blocking member reflecting or diffusing incident UV light. Exemplary materials for the chemical blocking member absorbing UV light include para-aminobenzoic acid (PABA) derivatives, cinnamate derivatives, salicylic acid derivatives, benzophenone and its derivatives, anthranilate and its derivatives, etc. Exemplary materials for the physical blocking member include zinc oxides, titanium oxides, iron oxides, magnesium oxides, etc. The UV filter 19 blocks UV light from entering the emitting layer 17, otherwise the UV light causes unnecessary light emission by exciting the emitting layer 17.

Meanwhile, the near blue-UV light source unit 20 is formed on a rear side of the rear plate 11. The near blue-UV light source unit 20 may include a near blue-UV lamp 21, for example, a blue light emitting diode (“LED”), a blue cold cathode tube, a plasma lamp, a mercury lamp, etc. A light guide/diffusion member 22 is disposed between the near blue-UV lamp 21 and the rear plate 11. The light guide/diffusion member 22 guides UV light emitted from the near blue-UV lamp 21 toward the rear plate 11 and uniformly diffuses the UV light. The light guide/diffusion member 22 is optional. When the light guide/diffusion member 22 is disposed between the near blue-UV lamp 21 and the rear plate 11, the near blue-UV lamp 21 has a size corresponding to a front surface of the rear plate 11. For instance, when the near blue-UV lamp 21 is implemented with a plurality of blue LEDs, the plurality of LEDs are arranged on a plane. When the near blue-UV lamp 21 is implemented with a cold cathode tube or plasma lamp, the cold cathode tube or plasma lamp has a size corresponding to the rear plate 11.

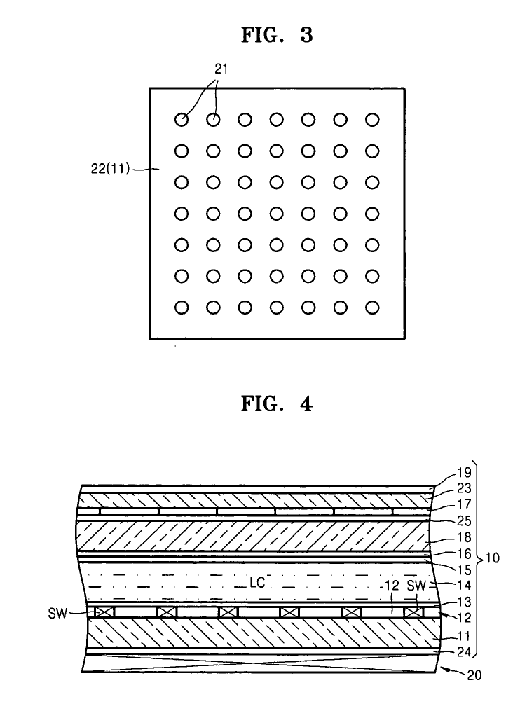

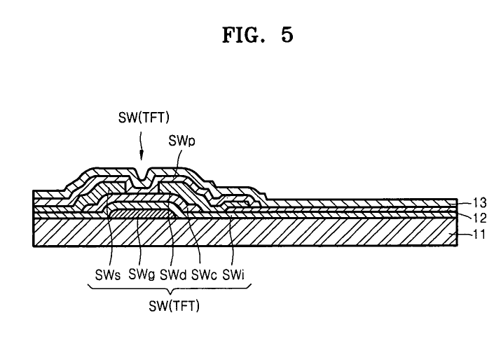

When the near blue-UV lamp 21 is implemented with a plurality of LEDs, the near blue-UV lamp 21 may have an edge lighting structure in which the plurality of LEDs may be arranged in a line along an edge of the light guide/diffusion member 22, as illustrated in FIG. 2. In another exemplary embodiment, as shown in FIG. 3, a plurality of LEDs can be arranged over the entire surface of the light guide/diffusion member 22 on the rear plate 11.

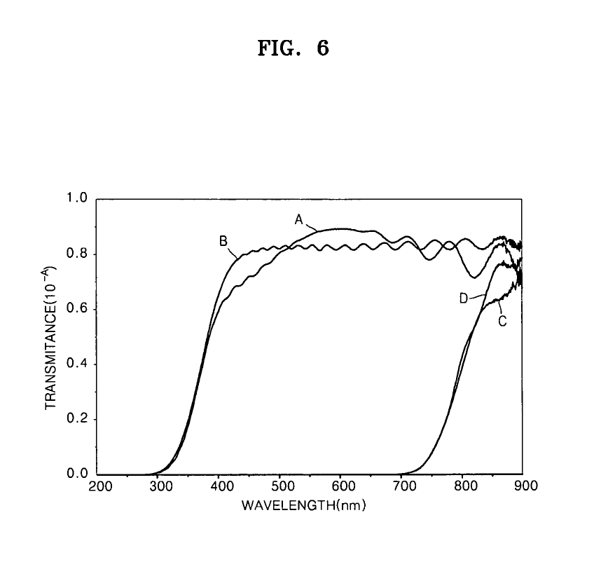

FIG. 4 is a schematic cross-sectional view of another exemplary embodiment of an LCD according to the present invention.

A difference between the LCD of the present exemplary embodiment and the LCD of the previous exemplary embodiment of FIG. 1 is the location of the UV filter 19. Referring to FIG. 4, the LCD includes a display panel 10 and a UV light source unit 20.

The display panel 10 includes a front plate 18 and a rear plate 11, which are separated a predetermined distance from one another, and a liquid crystal (“LC”) layer 14 is disposed in a space between the front and rear plates 18 and 11.

A common electrode 16 and an upper orientation layer 15 are sequentially disposed on an inner surface of the front plate 18. In addition, switching devices SW, such as thin film transistors (“TFT”), and a pixel electrode 12 are disposed on an inner surface of the rear plate 11, and a lower orientation layer 13 is disposed on the pixel electrode 12.

Polarizing layers 25 and 24 are respectively formed on outer surfaces of the front plate 18 and the rear plate 11. An emitting layer 17 emitting colored light by absorbing UV light are formed on the polarizing layer 25 on the front plate 18. The emitting layer 17, which emits colored light by absorbing UV light, may be composed of a common phosphor or photoluminescent material in ND form, which will be described later. The emitting layer 17 is covered with a protective substrate 23, and a UV filter 19 having the same function as described in the previous exemplary embodiment is formed on a surface of the protective substrate 23.

The UV filter 19 can be a chemical blocking member absorbing UV light or a physical blocking member reflecting or diffusing incident UV light. Examples of the chemical blocking member absorbing UV light include para-aminobenzoic acid (PABA) derivatives, cinnamate derivatives, salicylic acid derivatives, benzophenone and its derivatives, anthranilate and its derivatives, etc. Examples of the physical blocking member include zinc oxides, titanium oxides, iron oxides, magnesium oxides, etc. The UV filter 19 blocks UV light from entering the emitting layer 17, the UV light causes unnecessary light emission by exciting the emitting layer 17.

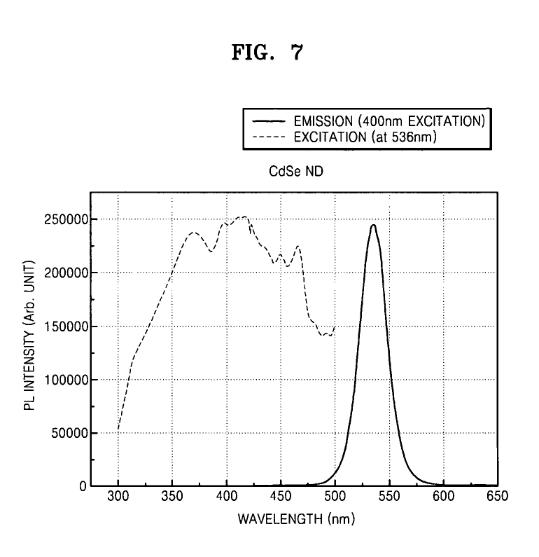

FIG. 5 is a cross-sectional view of the switching device SW (i.e., TFT) and the pixel electrode 12 in one of the LCDs according to the present invention.

Referring to FIG. 5, the TFT is a bottom-gate type TFT having a structure in which a gate SWg is formed below a silicon channel SWc. More specifically, the gate SWg is formed on a side region of the rear plate 11, and a gate insulating layer SWi is formed on the entire surface of the rear plate 11. The silicon channel SWc is formed the gate insulating layer SWi directly above the gate SWg. Also, the pixel electrode 12 is formed on the gate insulating layer SWi on a side of the silicon channel SWc. The pixel electrode 12 is a transparent electrode formed of, for example, indium tin oxide (ITO). Further, a source SWs and a drain SWd are formed on both sides of the silicon channel SWc, and a passivation layer SWp is formed thereon. The drain SWd extends to the pixel electrode 12 and is electrically coupled to the pixel electrode 12. The TFT and the pixel electrode 12 are completely covered with the lower orientation layer 13, which contacts and aligns LCs.

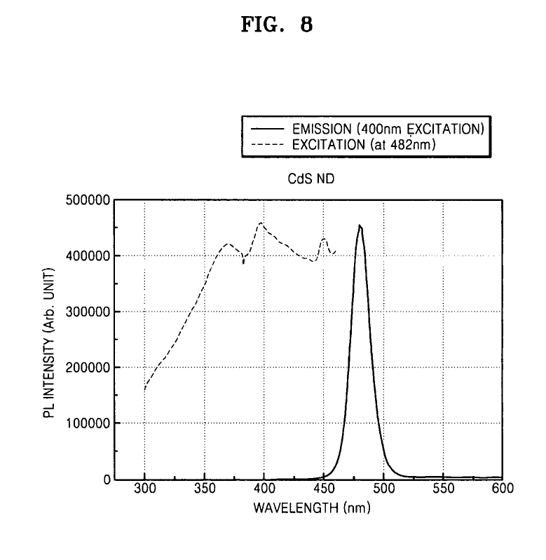

FIG. 6 is a graph of UV transmittance (absorbance) of samples with respect to a wavelength of light.

In FIG. 6, sample A is an LCD with two glass substrates on which ITO and polyimide are respectively coated, sample B is an LCD obtained by injecting LCs into sample A, sample C is an LCD obtained by attaching polarizers to inner surfaces of the two glass substrates of sample A, and sample D is an LCD obtained by injecting LCs into sample C.

Referring to FIG. 6, the transmittance of sample A sharply increases and the UV absorbance thereof sharply decreases near a wavelength of 300-400 nm. The UV absorbance of sample B sharply decreases near a wavelength of 400 nm below the absorbance of sample A. However, the transmittances of samples C and D sharply increases at a wavelength of 700-800 nm, while the UV absorbances of samples C and D are very high at wavelengths smaller than 700 nm.

In addition, as described above, the emitting layer 17 can be formed of a common phosphor that is excited by UV light or a photoluminescent material emitting light by being excited by near blue-UV light, both of the common phosphor and photoluminescent material being in ND form, which will be described below.

Table 1 is a list of phosphors of R, G, B colors which can be used in the present invention.

| | Phosphor |
|---|---|
| Red | Y₂O₂S: Eu³⁺ |
| | Y₂O₂S: Eu³⁺, Bi³⁺ |
| | YVO₄: Eu³⁺, Bi³⁺ |
| | Y₂O₃: Eu³⁺, Bi³⁺ |
| | SrS: Eu²⁺ |
| | (Ca, Sr)S: Eu²⁺ |
| | SrY₂S₄: Eu²⁺ |
| | CaLa₂S₄: Ce³⁺ |
| Green | YBO₃: Ce³⁺, Tb³⁺ |
| | BaMgAl₁₀O₁₇: Eu²⁺, Mn²⁺ |
| | (Sr, Ca, Ba)(Al, Ga)₂S₄: Eu²⁺ |
| | ZnS: Cu, Al |
| | Ca₈Mg(SiO₄)₄Cl₂: Eu²⁺, Mn²⁺ |
| | Ba₂SiO₄: Eu²⁺ |
| | (Ba, Sr)₂SiO₄: Eu²⁺ |
| | Ba₂(Mg, Zn)Si₂O₇: Eu²⁺ |
| | (Ba, Sr)Al₂O₄: Eu²⁺ |
| | Sr₂Si₃O₈.2SrCl₂: Eu²⁺ |
| Blue | (Sr, Mg, Ca)₁₀(PO₄)₆Cl₂: Eu²⁺ |
| | BaMgAl₁₀O₁₇: Eu²⁺ |
| | BaMg₂Al₁₆O₂₇: Eu²⁺ |

ND refers to semiconductor particles of specific sizes with a quantum confinement effect. The diameter of ND (or quantum dots) is in a range of about 1 nm to about 10 nm. Such quantum dots can be synthesized using a chemical wet method or a vapor phase method. In the chemical wet method, particles are grown from a precursor material in an organic solvent. This chemical wet method of synthesizing quantum dots is widely known.

The emitting layer 17 can be composed of a Group II-VI compound, a Group IV-VI compound, a Group IV compound, or a combination of these compounds of the periodic table, which are all in ND form.

Examples of the Group II-VI compound include CdSe, CdTe, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HggZnTe, CdZnSeS, CdZnSeTe, CdZnSTe, CdHgSeS, CdHgSeTe, CdHgSTe, HgZnSeS, HgZnSeTe, HgZnSTe, etc.

Examples of the Group III-V compound include GaN, GaP, GaAs, GaSb, AlN, AlP, AlAs, AlSb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb, etc.

Examples of the Group IV-VI compound include SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe, SnPbSTe, etc.

Examples of the Group IV compound include Si, Ge, SiC, SiGe, etc.

In addition, the quantum dots can have a core-shell structure. The core contains a material selected from the group consisting of CdSe, CdTe, CdS, ZnSe, ZnTe, ZnS, HgTe and HgS. The shell contains a material selected from the group consisting of CdSe, CdTe, CdS, ZnSe, ZnTe, ZnS, HgTe and HgS. A Group III-V compound, such as InP, etc., can be used for the shell.

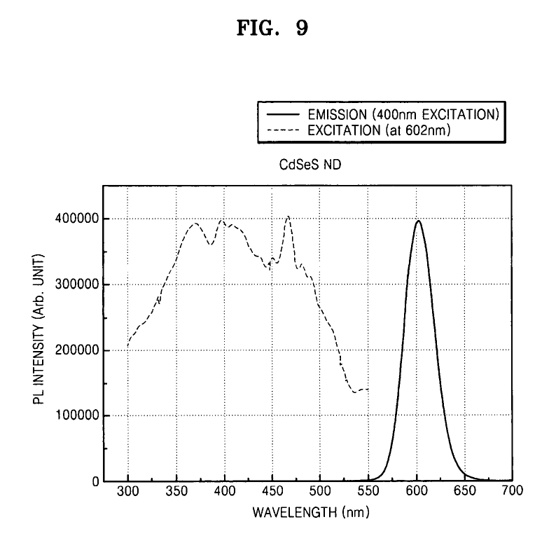

FIGS. 7 through 9 are graphs of photoluminescence (“PL”) of photoluminescent materials CdSe, CdS and CdSeS, respectively.

Referring to FIG. 7, CdSe ND, which is a green (G)-light emitting material, has a maximum PL near 420 nm and emits green (G) light having a center wavelength of about 530 nm by being excited by UV light of 400 nm.

Referring to FIG. 8, CdS ND, which is a blue (B)-light emitting material, has a maximum PL near about 400 nm and emits blue (B) light having a center wavelength of about 480 nm by being excited by UV light of 400 nm.

Referring to FIG. 9, CdSeS ND, which is a red (R)-light emitting material, has a maximum PL near 465 nm and emits red (R) light having a center wavelength of about 600 nm by being excited by UV light of 400 nm.

Considering the PL characteristics in FIGS. 7 through 9, it is apparent that R, G and B light can be generated as the photoluminescent materials are excited by UV light of 400 nm.

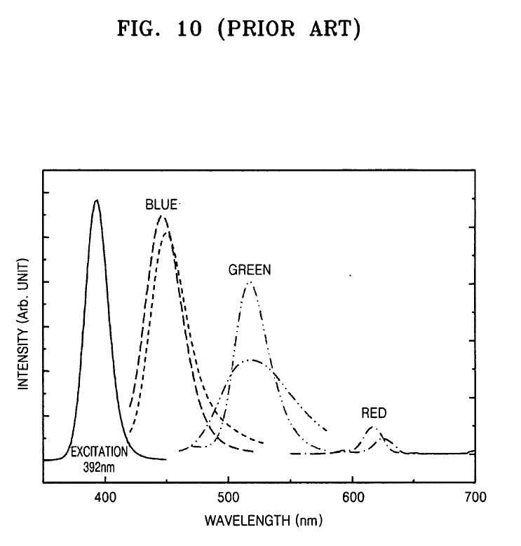

FIG. 10 is a graph of luminance of conventional R, G and B phosphors when excited by UV light of 392 nm in ambient light, such as external lighting or solar light. The results of FIG. 10 were obtained using two phosphors for each color manufactured by different companies and an LED of 392 nm as a light source.

As shown in FIG. 10, when excited by external light from the LED, i.e., UV light of about 392 nm, the two different blue phosphors emitted blue light having a shorter wavelength than the other colors and had similar intensities, the two green phosphors emitted green light having very different intensities, and the two red phosphors emitted red light each having relatively small intensities.

Considering these luminance characteristics of phosphors, light emission which is unnecessary for image display may occur on a front side of a PL-LCD in an environment with intense ambient light, thereby seriously reducing the contrast ratio for each color, especially for blue and green light.

Therefore, in an LCD according to the present invention, a UV filter is a used as a main component to prevent external light from entering the emitting layer of the LCD. As described above, a chemical or physical means can be used as the UV filter to prevent a decrease in contrast ratio caused by external light entering the emitting layer of the LCD.

In the preset invention, photoluminescent materials in ND form described above, which can be excited by UV light of 400 nm, may be used. This is because the UV light used to excite such photoluminescent materials is less absorbed by LCs and reduces the deterioration of LCs. In other words, when CdSeS, CdSe and CdS are respectively used for the R, G and B layers of the emitting layer 17, an LCD using UV light as an exciting light source emitting a wavelength of between about 360 nm to about 460 nm, for example, 400 nm, which is less absorbed by LCs, can be obtained. In an LCD using conventional phosphors, which are excited by UV light emitting a wavelength of 400 nm or less, LCs deteriorate by absorbing the UV light, and the luminous efficiency decreases to 70%. However, in the LCD according to the present invention, the deterioration of LCs is prevented due to the use of the photoluminescent materials in ND form, thereby extending the lifetime and increasing the high luminous efficiency up to 90% or more.

In addition, the UV filter used in the present invention blocks a range of wavelengths below a blue visible wavelength range of about 400 nm used to excite the photoluminescent materials. In other words, the range of wavelengths, which are blocked by the UV filter, does not include a visible wavelength range required to display an image.

Although active drive type LCDs using TFTs are described in the above-described exemplary embodiments of the present invention, the present invention is not limited thereto. For example, an LCD according to the present invention can be a simple matrix type LCD which does not use a switch device.

As described above, in an LCD according to the present invention, the UV absorption by LCs decreases, thereby preventing damage of LCs and increasing the UV utilization efficiency and lifetime of the LCD. In addition, the excitation of the emitting layer by external light, which is a drawback of PL-LCDs, and a decrease in contrast ratio are prevented. Therefore, the LCD according to the present invention can display a high quality image with high luminance and high luminous efficiency.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A photoluminescent liquid crystal display comprising:
a front plate and a rear plate;
liquid crystals disposed between the front and rear plates;
an electrode that is disposed on an inner surface of each of the front and rear plates and forms an electric field in the liquid crystals;
an emitting layer that is formed on the front plate and emits visible light by being excited by light of a wavelength of about 390 nm to about 410 nm;
a light source unit formed on a rear side of the rear plate, the light source unit including a lamp emitting near blue-UV light having a wavelength of about 390 nm to about 410 nm toward the emitting layer; and
a UV filter blocking UV rays in ambient light from entering a front side of the front plate.

2. The photoluminescent liquid crystal display of claim 1, wherein the lamp comprises a blue-light emitting diode (LED).

3. The photoluminescent liquid crystal display of claim 1, wherein the lamp comprises one of a blue cold cathode tube, a plasma lamp, a mercury lamp, or a plurality of blue-light emitting diodes (LEDs).

4. The photoluminescent liquid crystal display of claim 1, wherein the light source unit comprises a light guide/diffusion member that guides the light emitted from the lamp toward the rear plate and uniformly diffuses the light over the rear plate.

5. The photoluminescent liquid crystal display of claim 2, wherein the lamp comprises a plurality of light emitting diodes arranged along an edge of the light guide/diffusion member.

6. The photoluminescent liquid crystal display of claim 4, wherein the lamp comprises a plurality of light emitting diodes arranged over an entire surface of the light guide/diffusion member.

7. The photoluminescent liquid crystal display of claim 1, wherein the UV filter is a chemical blocking member absorbing the UV rays.

8. The photoluminescent liquid crystal display of claim 7, wherein the chemical blocking member is formed of a material selected from the group consisting of para-aminobenzoic acid (PABA) derivatives, cinnamate derivatives, salicylic acid derivatives, benzophenone and its derivatives, and anthranilate and its derivatives.

9. The photoluminescent liquid crystal display of claim 1, wherein the UV filter is a physical blocking member reflecting and diffusing the UV rays.

10. The photoluminescent liquid crystal display of claim 1, wherein the physical blocking member is formed of a material selected from the group consisting of zinc oxides, titanium oxides, iron oxides and magnesium oxides.

11. The photoluminescent liquid crystal display of claim 1, wherein the emitting layer is formed on an outer surface of the front plate, a protective glass substrate is further formed on the emitting layer, and the UV filter is formed on the protective glass substrate.

12. The photoluminescent liquid crystal display of claim 1, wherein the emitting layer includes at least one material selected from the group consisting of a Group II-VI compound, a Group IV-VI compound, a Group IV compound, and a combination of these compounds.

13. The photoluminescent liquid crystal display of claim 12, wherein the Group Il-VI compound is selected from the group consisting of CdSe, CdTe, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HggZnTe, CdZnSeS, CdZnSeTe, CdZnSTe, CdHgSeS, CdHgSeTe, CdHgSTe, HgZnSeS, HgZnSeTe, and HgZnSTe;
the Group II-V compound is selected from the group consisting of GaN, GaP, GaAs, GaSb, AlN, AlP, AlAs, AlSb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, and InAlPSb;
the Group IV-VI compound is selected from the group consisting of SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe, and SnPbSTe; and
the Group IV compound is selected from the group consisting of Si, Ge, SiC, and SiGe.

14. The photoluminescent liquid crystal display of claim 1, wherein the emitting layer comprises R, G and B layers.

15. The photoluminescent liquid crystal display of claim 1, wherein the emitting layer comprises a common phosphor of photoluminescent material in nanodot (“ND”) form.

16. The photoluminescent liquid crystal display of claim 15, wherein the diameter of the ND (or quantum dots) is in a range of about 1 nm to about 10 nm.

17. The photoluminescent liquid crystal display of claim 16, wherein the quantum dots have a core-shell structure.

18. The photoluminescent liquid crystal display of claim 17, wherein the core contains a material selected from the group consisting of CdSe, CdTe, CdS, ZnSe, ZnTe, ZnS, HgTe and HgS, and the shell contains a material selected from the group consisting of CdSe, CdTe, CdS, ZnSe, ZnTe, ZnS, HgTe and HgS.

19. The photoluminescent liquid crystal display of claim 17, wherein the shell is formed of a material selected from a Group III-V.
